(19) United States
(12) Patent Application Publication
(10) Pub. No.: US 2017/0030873 A1
(43) Pub. Date: Feb. 2, 2017

(54) Thermal Conductivity Detector

(71) Applicant: Siemens Aktiengesellschaft, Muenchen (DE)

(72) Inventor: Udo GELLERT, Bellheim (DE)

(21) Appl. No.: 15/303,320

(22) PCT Filed: Apr. 13, 2015
(86) PCT No.: PCT/EP2015/057991

§ 371 Date: Oct. 11, 2016

(30) Foreign Application Priority Data
Apr. 14, 2014 (EP) 14164549.9

(51) Int. Cl. G01N 30/66; G01N 27/18; G01F 1/708

(52) U.S. Cl. CPC G01N 30/66; G01F 1/7084; G01N 27/185; G01N 2030/621

(57) ABSTRACT

A thermal conductivity detector which includes a measurement channel, an electrically heatable heating filament extending longitudinally along the center of the measurement channel so that a fluid passing through the measurement channel flows around the filament, an evaluator that detects electrical resistance changes of the heating filament and provide an output representative of the presence and amount of various fluid components passing the heating filament, and a bypass channel for bypassing the measurement channel, where the bypass channel has a lower fluidic resistance than the measurement channel and where, in order to improve the detection capability, the thermal conductivity detector further includes a flow sensor for measuring the flow of the fluid in the bypass channel and for providing an output indicative of the measured flow, and a correcting device for correcting the output of the evaluator using the output of the flow sensor.

### CROSS-REFERENCE TO RELATED APPLICATIONS

This is a U.S. national stage of application No. PCT/EP2015/057991 filed 13 Apr. 2015. Priority is claimed on European Application No. 14164549 filed 14 Apr. 2014, the content of which is incorporated herein by reference in its entirety.

### BACKGROUND OF THE INVENTION

1. Field of the Invention

The present invention relates to a thermal conductivity detector comprising a measurement channel, an electrically heatable heating filament extending longitudinally along the center of the measurement channel such that a fluid passing through the measurement channel flows around the filament, an evaluator for detecting electrical resistance changes of the heating filament and for providing an output representative of the presence and amount of various fluid components passing around the heating filament, and a bypass channel for bypassing the measurement channel, where the bypass channel has a lower fluidic resistance than the measurement channel.

2. Description of the Related Art

U.S. Pat. No. 3,768,301 A, GB 2 131 180 A and/or EP 2 431 737 A1 each disclose a thermal conductivity.

Thermal conductivity detectors such as known from U.S. Pat. No. 6,896,406 B2, WO 2009/095494 A1 or DE 10 2009 014 618 A1 25 are used to detect certain liquid or gaseous substances (fluids) based on their characteristic thermal conductivity, particularly in gas chromatography. For this purpose, the substances to be detected, after their chromatographic separation, are successively guided past an electrically heated filament disposed in a measurement channel. Depending on the thermal conductivity of the substance flowing past the electrically heated filament, more or less heat is diverted from the heating filament to the wall of the measurement channel, and the heating filament is correspondingly cooled to a greater or lesser degree. As a result of the cooling of the heating filament, its electrical resistance changes, which is detected. For this purpose, the heating filament maybe disposed in a measuring bridge, which contains additional resistors and an additional heating filament in a reference channel through which a reference fluid flows (e.g. U.S. Pat. No. 5,756,878; FIG. 8). The thermal conductivity of the substance passing the heating filament is obtained from an amount of energy that is supplied to the measuring bridge and is controlled to maintain the temperature of the heating filament at a predetermined temperature. Instead of the resistors, further filaments may be provided that are fluidically parallel or in series with the filaments in the measurement channel and the reference channel, respectively.

It is also known to locate a temperature sensing filament in the wall of the measurement channel (e.g., U.S. Pat. No. 5,756,878, FIGS. 2 and 6; U.S. Pat. No. 5,587,520). In this case, the thermal conductivity of the substance passing the heating filament is obtained from an amount of energy that is supplied to the measuring bridge and is controlled to keep the difference between the temperature of the heated filament and the wall temperature measured by the temperature sensing filament at a constant value. Thus, the detector output is independent of variations of the ambient temperature such as caused by thermal crosstalk from adjacent detectors and/or thermal waves, in particular heat waves which emanate from an oven of a gas chromatograph.

As the cooling of the heating filament in the measurement channel is not only dependent on the thermal conductivity of the substance to be measured, but also on the velocity with which the fluid passes by the heating filament, variations in the fluid flow through the measurement channel will affect the measurement result. A problem may thus occur in a gas chromatograph with variations in the carrier gas flow, e.g., when the pressure is ramped, i.e., linearly varied with time, or when the carrier gas is switched between different separation columns. In order to reduce the sensitivity to changes in the fluid flow, a bypass can be provided for bypassing the measurement channel (e.g., U.S. Pat. No. 3,768,301, FIG. 6). The influence of variations in the carrier gas flow on the measurement result will therefore be reduced by the split ratio of the flow through measurement channel and the flow through the bypass channel. However, the lower the flow through measurement channel, the more insensitive the thermal conductivity detector is to the substances to be measured.

U.S. Pat. No. 4,850,714 discloses a thermal conductivity detector having a measurement channel and a bypass channel. Here, two measuring resistors are arranged in the measurement channel behind each other in the flow direction to compensate for flow dependence. Each measuring resistor is configured in a serpentine pattern and oriented perpendicularly o the flow direction. The measuring resistors are arranged in diagonally opposite arms of a measuring bridge, such that the heat transfer from the measuring resistors to the wall of the measurement channel due to thermal conduction and the heat transfer between the measuring resistors due to flow will have opposite effects on the balance of the bridge. The arrangement, orientation and design of the two measuring resistors, however, impedes the flow through the measurement channel and may destroy or corrupt a chromatographically separated sample making it unusable for further separation and analysis.

### SUMMARY OF THE INVENTION

In view of the foregoing, it is an object of the present invention to provide a thermal conductivity detector with improved detection capability.

This and other objects and advantages are achieved in accordance with the invention by a thermal conductivity detector which further comprises a flow sensor for measuring the flow of the fluid in the bypass channel and providing an output indicative of the measured flow, and correcting means for correcting the output of an evaluator using the output of the flow sensor.

Thus, the influence of variations in the fluid flow on the measurement result will not only be reduced but will be compensated. The flow through the measurement channel is, in the above mentioned split ratio, proportional to the flow sensed in the bypass channel. The split ratio, in turn, is inversely proportional to the ratio of the fluidic resistances of the measurement channel and the bypass channel. Thus, the flow through the measurement channel can be determined and is used for correcting the measurement of thermal conductivity without interfering with it.

The flow sensor is preferably a thermal type sensor so that the same technology is used for sensing the flow and the thermal conductivity. This facilitates manufacturing of the thermal conductivity detector which is preferably realized in MEMS (Micro-Electro-Mechanical System) technology. The three basic types of thermal flow sensors include anemometers, calorimetric flow sensors and time-of-flight flow sensors, the latter of being preferably used with the thermal conductivity detector in accordance with the invention because it measures the flow unaffected by temperature, composition, thermal conductivity and viscosity of the fluid.

The lower fluidic resistance of the bypass channel compared to the measurement channel can be achieved in that the bypass channel has a larger inner width and/or a shorter length than the measurement channel. Alternatively, or additionally, the measurement channel and the bypass channel may asymmetrically branch out from a common fluid delivery channel, where the fluid delivery channel continues straight into the bypass channel in the simplest case. This means that the branching angle of the measurement channel is larger than the branching angle of the bypass channel; the latter may even be zero. The split ratio of the partial flows through the measurement channel and the bypass channel is set by the branching angles of the two channels.

In gas chromatography, components or substances of a gas mixture are separated by passing a sample of the gas mixture in a carrier gas (mobile phase) through a separation column containing a stationary phase. The different components interact with the stationary phase which causes each component to elute at a different time, known as the retention time of the component. There are two general types of separation column, packed or capillary (open tubular).

Packed columns consist of a tube filled with packing material. The stationary phase is applied to the surface of the packing material such as small particles. In capillary columns, the stationary phase is applied directly onto the inner wall of the capillary. Particularly, porous layer open tubular (PLOT) columns are made by coating a layer of small particles on the inner wall of the capillary. A problem with packed columns filled with small particles and, in particular, with PLOT columns is that any change of gas velocity, pressure, surface stress or vibration may result in a release of particles. Such particles are swapped by the carrier gas to the detector and will lead to noise in the form of spikes in the detector output. Particles released from packed columns or PLOT columns have a higher mass than the gas molecules and thus will have a higher inertia. Accordingly and as the bypass channel has a lower fluidic resistance than the measurement channel, the particles will be entrained by the carrier gas flow into the bypass channel where the current is stronger. Thus, the gas flow through the measurement channel will be largely free of particles and the measurement will not be disturbed.

Nevertheless, it may happen that a single or multiple particles get lodged between the heating filament and the wall of the measurement channel, which might affect the accuracy of measurement, and can lead to the destruction of the thermal conductivity detector. For this reason, the thermal conductivity detector preferably comprises at least one particle filter upstream of the heating filament. The particle filter comprises a channel section of reduced cross-section of the measurement channel and a retaining bar diametrically traversing the channel section. The gap between the retaining bar and the wall of the channel section is smaller than half the diameter of the measurement channel so that larger particles will be trapped. The retaining bar can be advantageously manufactured in the same way as and together with the supporting members that hold the heating filament. In order to protect the flow sensor, another similar particle filter may be arranged upstream of the flow sensor. The further particle filter comprises a channel section of reduced cross-section of the bypass channel and a retaining bar diametrically traversing the channel section.

As the thermal conductivity detector in accordance with the invention shows its advantages in particular in gas chromatography, a gas chromatograph comprising at least one thermal conductivity detector as described so far is a further subject of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will now be described by way of example and with reference to the accompanying drawing, in which:

FIG. 1 is a simplified schematic block diagram of an exemplary gas chromatograph in accordance with the invention;

FIG. 2 is a first exemplary embodiment of the thermal conductivity detector in accordance with the invention;

FIG. 3 is a simplified scheme of a modified version of the thermal conductivity detector of FIG. 2;

FIG. 4 is another exemplary embodiment of the thermal conductivity detector of FIG. 2; and

FIG. 5 is an exemplary embodiment of a portion of the thermal conductivity detector with particle filters in accordance with the invention.

### DETAILED DESCRIPTION OF THE EXEMPLARY EMBODIMENTS

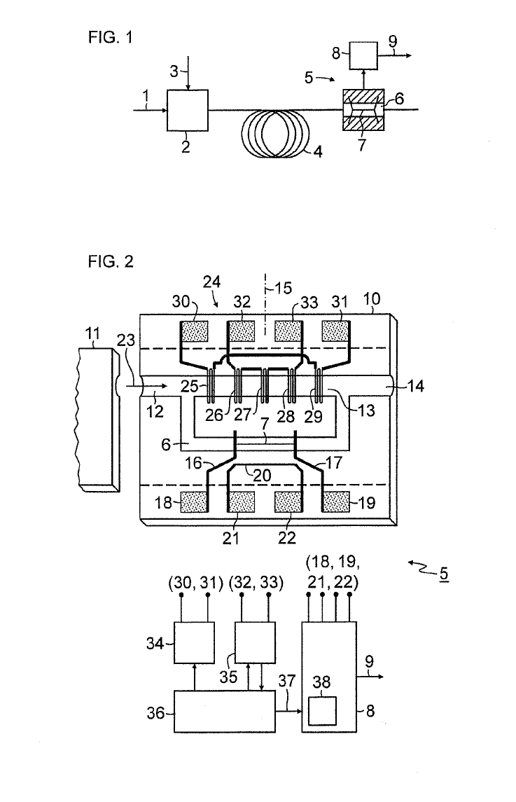

FIG. 1 shows a gas chromatograph in which a carrier gas 1 is delivered to an injector 2, loaded there with a sample of a gas mixture 3 to be analyzed and subsequently introduced into a separating device 4 such as a single separation column or a complete system of separation columns. The separated components or substances of the gas mixture emerging successively from the separating device 4 travel to a thermal conductivity detector 5. There, the separated gas components are conveyed in a measurement channel 6 past an electrically heated heating filament 7 arranged therein. Depending on the thermal conductivity of the gas components respectively flowing past in comparison with that of the carrier gas, more or less heat is transferred from the heating filament 7 to the channel wall so that the heating filament 7 is correspondingly cooled or heated. As a result, the electrical resistance of the heating filament 7 changes, which change is detected in an evaluation device 8 of the detector 5. To this end, the heating filament 7 may be arranged in a measurement bridge (not shown) that contains another heating filament in a further channel through which a reference gas, for example, the carrier gas 1, flows or, as described in detail below with reference to FIG. 2, preferably contains a temperature sensing filament that is located in the wall of the measurement channel. The evaluation device 8 provides an output 9 that indicates the presence and amount of the gas components passing the heating filament 7.

FIG. 2 shows an exemplary embodiment of the thermal conductivity detector 5 including a carrier plate 10 and a cover plate 11, which, in an assembled state, are positioned on top of one another and are joined together. The plates 10, 11 have congruent structures of grooves on their sides that face each other. The congruent grooves have semicircular cross sections and form channels that communicate with each other. The channels include, in particular, a fluid delivery channel 12 that branches in the measurement channel 6 and a bypass channel 13 which, for their part, end in a common fluid outlet channel 14. The branching of the measurement channel 6 and bypass channel 13 from fluid delivery channel 12 is asymmetrical with the fluid delivery channel 12 continuing straight into the bypass channel 13 and the measurement channel 6 diverging at a right or obtuse angle. Furthermore, the bypass channel 13 has a larger inner width than the measurement channel 6. The channel structure is formed in bilateral symmetry with respect to an axis 15 so that the fluid delivery channel 12 and the fluid outlet channel 14 may be used interchangeably.

A heating filament 7 is suspended longitudinally along the center of the measurement channel 6 between two electrically conductive supporting arms 16 and 17, which are formed on the side of the plate containing the grooves and which intersect the measurement channel 6. The supporting arms 16 and 17 end in contact pads 18 and 19, which are disposed on the carrier plate 10 in a region that is not covered by the plate 11. A temperature sensing filament is located in the wall of the measurement channel 6 and connected to further contact pads 21 and 22. The heating filament 7 and the temperature sensing filament 20 are, via their respective contact pads 18, 19, 21, 22, connected to the evaluation device 8 which determines the presence and amount of a substance passing the heating filament 7 from the heat flow from the heating filament 7 to the wall of the measurement channel 6. The heat flow, for its part, is determined from an amount of energy that is supplied to the heating filament 7 and is controlled to keep the difference between the temperature of the heating filament 7 and the wall temperature measured by the temperature sensing filament 20 at a constant value.

The inlet flow of a fluid 23 coming from, e.g., the separating device 4 of FIG. 1 is divided into a smaller flow through the measurement channel 6 and a bigger flow through the bypass channel 13. As the flow through the measurement channel 6 is proportional to the flow in the bypass channel 13, the latter flow is sensed and used for correcting the measurement of thermal conductivity without interfering with it.

For that purpose, a thermal time-of-flight flow sensor 24 is provided in the bypass channel 13. The thermal time-of-flight flow sensor 24 comprises several single or multiple folded conductive filaments 25, 26, 27, 28, 29 which are, preferably evenly, distributed along the bypass channel 13 and each cross the bypass channel 13. The outer filaments 25 and 29 are connected in series between two contact pads 30 and 31. The inner filaments 26-28 are also connected in series between two contact pads 32 and 33. The flow sensor 24 is based on the time-of-flight of a thermal pulse which is generated by the outer filaments 25 and 29, more exactly by one of the outer filaments that is situated upstream in the flow direction. To this end, the outer filaments 25 and 29 are, via their contact pads 30 and 31, connected to an electrical pulse generator 34. The time-of-flight of the generated thermal pulse is measured via at least one of the inner 15 sensing filaments 26, 27, 28. To this end, the inner filaments 26, 27, 28 are via their contact pads 32 and 33, connected to a resistance measurement circuit (ohmmeter) 35. The electrical pulse generator 34 and the resistance measurement circuit 35 are connected to a computing unit 36 that synchronizes generation and detection of the heat pulses and provides an output 37 indicating the flow in the bypass channel 13. This output 37 is provided to correcting means 38 in the evaluation device 8 for correcting the measurement of thermal conductivity, i.e., for correcting the measuring value of the amount of a substance passing the heating filament 7.

As described so far, the thermal flow sensor 24 is preferably based on the thermal time-of-flight principle that allows for measuring the flow unaffected by temperature, composition, thermal conductivity and viscosity of the fluid. If the flow sensor is of another type, such as an anemometric or calorimetric type, its output may be corrected by using the temperature measured by the temperature sensing filament 20 or another temperature sensor and/or using the thermal conductivity measured in the measurement channel 6.

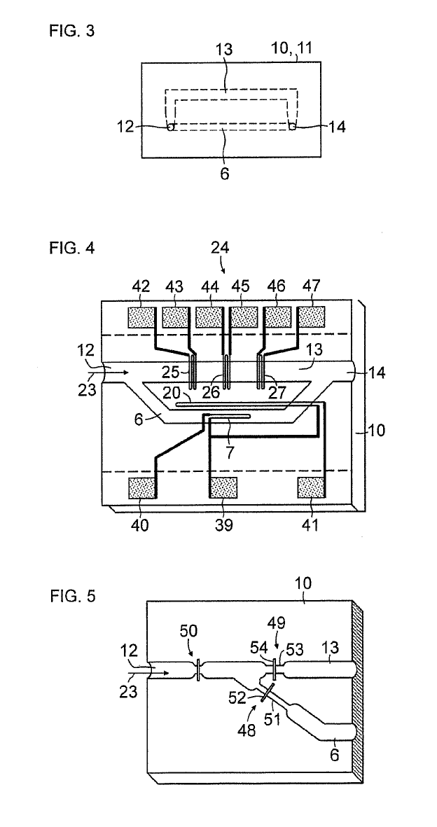

FIG. 3 shows in a very simplified manner another version of the thermal conductivity detector 5 (i.e., the composite of the plates 10 and 11) with the fluid delivery channel 12 and the fluid outlet channel 14 running through the cover plate 11 and perpendicularly to the measurement channel 6 and the bypass channel 13.

FIG. 4 shows another exemplary embodiment of the thermal conductivity detector 5 (here only plate 10) which mainly differs from that of FIG. 1 in that the heating filament 7 and the temperature sensing filament 20 are each formed as a single folded loop. The filaments 7 and 20 are connected in series with a middle and two outer connection pads 39, 40 and 41 so that they can easily be joined into a measuring bridge circuit. The thermal flow sensor 24 comprises three filaments 25, 26, 27 similar to those of FIG. 2, however, each with its own connection pads 42, 43, 44, 45, 46, 47. The measurement channel 6 branches off from the fluid delivery channel 12 at an obtuse angle, where the fluid delivery channel 12 continues straight ahead into the bypass channel 13.

FIG. 5 shows an exemplary embodiment of a portion of the thermal conductivity detector 5 (here only plate 10) with particle filters 48, 49, 50. The particle filter 48 is arranged upstream of the heating filament in the measurement channel 6 and comprises a channel section 51 of reduced cross-section of the measurement channel 6 and a retaining bar 52 diametrically traversing the channel section 51. The particle filter 49 is arranged upstream of the flow sensor in the bypass channel 13 and comprises a channel section 53 of reduced cross-section of the bypass channel 13 and a retaining bar 54 diametrically traversing the channel section 53. Thus, the cross-section of channel section 53 is wider than that of channel section 51. The particle filter 50 in the fluid delivery channel 12 is optional.

In another exemplary embodiment of the thermal conductivity detector 5 (here only plate 10), which mainly differs from that of FIG. 1, the heating filament 7 and the temperature sensing filament 20 are each formed as a single folded loop.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those element steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. A thermal conductivity detector comprising:
a measurement channel;
an electrically heatable heating filament extending longitudinally along a center of the measurement channel such that a fluid passing through the measurement channel flows around the filament;
an evaluator which detects electrical resistance changes of the heating filament and provides an output representing a presence and amount of various fluid components flowing around the heating filament;
a bypass channel for bypassing the measurement channel, said bypass channel having a lower fluidic resistance than the measurement channel;
a flow sensor for measuring the flow of the fluid in the bypass channel and for providing an output indicative of the measured flow of the fluid; and
correcting means for correcting the output of the evaluator using an output of the flow sensor.

13. The thermal conductivity detector of claim 12, wherein the flow sensor is a thermal type flow sensor.

14. The thermal conductivity detector of claim 12, wherein the flow sensor is a time-of-flight sensor.

15. The thermal conductivity detector of claim 13, wherein the flow sensor is a time-of-flight sensor.

16. The thermal conductivity detector of claim 12, wherein the bypass channel has a larger inner width than the measurement channel.

17. The thermal conductivity detector of claim 12, wherein the bypass channel has a shorter length than the measurement channel.

18. The thermal conductivity detector of claim 12, wherein the measurement channel and the bypass channel branch out asymmetrically from a common fluid delivery channel.

19. The thermal conductivity detector of claim 18, wherein the fluid delivery channel continues straight into the bypass channel.

20. The thermal conductivity detector of claim 12, further comprising:
at least one particle filter arranged upstream of the heating filament, the at least one particle filter comprising a channel section of reduced cross-section of the measurement channel and a retaining bar diametrically traversing the channel section.

21. The thermal conductivity detector of claim 20, further comprising:
at least one further particle filter arranged upstream of the flow sensor, the further particle filter comprising a channel section of reduced cross-section of the bypass channel and a retaining bar diametrically traversing the channel section.

22. The thermal conductivity detector of claim 12, wherein the thermal conductivity detector is a MEMS (Micro-Electro-Mechanical System) based device.

23. A gas chromatograph comprising at least one thermal conductivity detector of claim 12.
